(19) United States
(12) Patent Application Publication
(10) Pub. No.: US 2005/0113998 A1
(43) Pub. Date: May 26, 2005

(54) Electronically-controlled suspension apparatus and damping force control method

(75) Inventor: Wanil Kim, Kyonggi-do (KR)

Correspondence Address: BACON & THOMAS, PLLC, 625 SLATERS LANE, FOURTH FLOOR, ALEXANDRIA, VA, 22314, US

(73) Assignee: Mando Corporation, Kyonggi-do (KR)

(21) Appl. No.: 10/995,419

(22) Filed: Nov. 24, 2004

(30) Foreign Application Priority Data
Nov. 23, 2003 (KR) 10-2003-0084379

(51) Int. Cl. G06F 7/00

(52) U.S. Cl. 701/37; 701/38

(57) ABSTRACT

An electronically-controlled suspension apparatus includes a stroke detecting unit for detecting a relative displacement of the vehicle body with respect to the wheel axle; a stroke response control unit for determining a control command adjusted valve; and an actuating unit which is operated according to the control command adjusted value, thus adjusting the extension or compression damping force of the damper. The stroke response control unit determines the control command adjusted value for increasing an extension or compression damping force of the damper when the relative displacement is equal to or greater than a first predetermined value, or is less than or equal to a second predetermined value.

### FIELD OF THE INVENTION

The present invention relates to an electronically-controlled suspension apparatus; and, more particularly, to an electronically-controlled suspension apparatus and damping force control method, which is capable of preventing a full extension or a full bumping of a damper by changing damping force characteristics of the damper when a stroke of the damper is within a critical stroke range.

### BACKGROUND OF THE INVENTION

In general, a suspension apparatus connects a wheel axle to a vehicle body to prevent vibrations and impacts transmitted from vehicle wheels from being directly transmitted to the vehicle body, so that it can prevent a vehicle body and goods contained therein from being damaged and improve riding comfort of a vehicle. Also, the suspension apparatus transfers to the vehicle body either a driving force generated from driving wheels or brake force of individual wheels when braking the vehicle to a stop, endures a centrifugal force generated during a turning movement of the vehicle, and maintains the individual wheels at accurate positions on the basis of the vehicle body.

Further, an electronically-controlled suspension apparatus includes various sensors mounted to the vehicle, and adjusts damping force characteristics of dampers by using values detected by the sensors, thus enhancing the riding comfort and a driving stability of the vehicle. In particular, the electronically-controlled suspension apparatus has a plural number of vertical acceleration sensors each of which is disposed at the vehicle body above the vehicle wheel to detect the motion of the vehicle body. Therefore, the electronically-controlled suspension apparatus can independently control the damping force characteristics of the dampers.

More specifically, such conventional electronically-controlled suspension apparatus basically includes a sensing unit, dampers, actuating units and an electronic control unit (ECU).

The actuating unit is constituted by a device, such as a variable solenoid valve or a step motor, and controls the damping force characteristics of the corresponding damper according to an output of the electronic control unit.

The sensing unit includes a first sensing device for detecting vertical movements of the vehicle body, such as a vehicle body vertical acceleration sensor and a vehicle height sensor, a second sensing device for detecting lateral movements of the vehicle, such as a steering angle sensor and a horizontal acceleration sensor, and/or a third sensing device for sensing longitudinal movements of the vehicle, such as a speed sensor, a brake on/off sensor and a TPS (throttle position sensor).

In the conventional electronically-controlled suspension apparatus, the damper is of a variable damper, which has at least two (e.g., soft and hard) damping force characteristic curves, that can be switched in a plurality of steps or continuously by the operation of the corresponding actuating unit. The dampers suppress the transferring of the vibration caused by an uneven road from the wheels to the vehicle body, thus enhancing the riding comfort of the vehicle. Furthermore, the dampers suppress variation of a traction force, thus enhancing the driving stability of the vehicle.

When the vehicle runs over a protrusion, such as a bump, on a road or on a very uneven road, the amplitude of vibration of the vehicle body with respect to the wheel axle may be increased to reach a stroke limit of the damper (this event is called a full extension or a full bumping). To reduce impacts and noises caused by the full extension or the full bumping, the damper incorporates therein a stop rubber and a bumper rubber.

The electronic control unit receives a piece of information about a driving state of the vehicle, road surface conditions and intention of a driver, detected by the sensing unit, and applies the piece of information to a control algorithm provided in the electronic control unit, thus determining a damping force control command to control the damping force of the damper. Furthermore, the electronic control unit has a memory in which variables used according to a mode selected by a driver are stored.

The electronic control unit includes a riding comfort control part for reducing the vibration transferred from the road to the vehicle body, a roll control part for enhancing the stability of the vehicle during turning movements thereof, and a dive and squat control part for preventing a nose-up or nose-down of the vehicle body when the vehicle is accelerated or decelerated. The riding comfort control part controls the damping force of the damper in proportion to an absolute speed of the vehicle body using a so-called ‘Sky-hook damper theory’.

However, in the case where the sky-hook damper theory is adapted to enhance the riding comfort of the vehicle and the damper having damping force characteristics softer than those of a general damper for normal operation of the vehicle is mounted to the vehicle, when the vehicle runs over the protrusion or a pothole of the road, the full extension or the full bumping may occur. In this case, the riding comfort of the vehicle is deteriorated and the durability of inner components of the damper is reduced. Particularly, when the stop rubber installed in the inside of the damper is damaged by impacts made thereon due to the full extension, foreign matters, such as rubber particles, may be generated in the inside of the damper. In addition, if the undesirable material is lodged into an orifice of the actuating unit for adjusting the damping force characteristics of the damper, incorrect operation or failure of the damper may occur.

Further, there has been presented a stroke response damper with a cylinder having a longitudinal groove formed on an inner surface thereof. Damping force characteristics of the stroke response damper are kept soft when the stroke of the stroke response damper is within a stroke section corresponding to the longitudinal groove of the cylinder. Meanwhile, the damping force characteristics of the stroke response damper are kept hard when the stroke is within a stroke section other than the stroke section corresponding to the longitudinal groove of the cylinder, for example, within a critical stroke range. However, the stroke response damper is disadvantageous in that the damping force thereof varies discontinuously and abruptly deteriorating the driving comfort of the vehicle.

### SUMMARY OF THE INVENTION

It is, therefore, an object of the present invention to provide an electronically-controlled suspension apparatus and damping force control method which hardens damping force characteristics of a damper when a stroke of the damper (or a relative displacement of a vehicle body with respect to a wheel axle) is in a critical stroke range, thus preventing a full extension or a full bumping from occurring in the damper, thereby preventing inner components of the damper from being damaged and enhancing the riding comfort of a vehicle.

In accordance with one aspect of the present invention, there is provided an electronically-controlled suspension apparatus, which is provided with a damper installed between a vehicle body and a wheel axle, including: a stroke detecting unit for detecting a relative displacement of the vehicle body with respect to the wheel axle; a stroke response control unit, which determines a control command adjusted value for increasing an extension or compression damping force of the damper when the relative displacement is equal to or greater than a first predetermined value, or is less than or equal to a second predetermined value; and an actuating unit which is operated according to the control command adjusted value, thus adjusting the extension or compression damping force of the damper.

In accordance with another aspect of the present invention, there is provided a damping force control method of an electronically-controlled suspension apparatus which determines a control command value for controlling a damping force of a damper by using a piece of information about a driving state of a vehicle, road surface characteristics or intention of a driver, detected by sensing means, the damper being installed between a vehicle body and a wheel axle, the method including: detecting a relative displacement of the vehicle body with respect to the wheel axle; determining whether the relative displacement is equal to or greater than a first predetermined value, or is less than or equal to a second predetermined value; determining a first control command adjusted value for increasing an extension damping force of the damper by adjusting the control command value when the relative displacement is equal to or greater than the first predetermined value; determining a second control command adjusted value for increasing a compression damping force of the damper by adjusting the control command value when the relative displacement is less than or equal to the second predetermined value; and adjusting the damping force of the damper according to the first or second control command adjusted value.

In accordance with still another aspect of the present invention, there is provided a damping force control method of an electronically-controlled suspension apparatus which determines a control command value for controlling a damping force of a damper by using a piece of information about a driving state of a vehicle, road surface characteristics or intention of a driver, detected by sensing means, the damper being installed between a vehicle body and a wheel axle, the method including: obtaining a relative displacement of the vehicle body with respect to the wheel axle, and a relative velocity; determining whether the relative displacement is equal to or greater than a first predetermined value, or is less than or equal to a second predetermined value, and whether or not the relative velocity is greater than 0; determining a control command adjusted value by adjusting the control command value according to the relative displacement and the relative velocity, thus increasing or reducing an extension or an compression damping force of the damper; and adjusting the damping force of the damper according to the control command adjusted value.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of an electronically-controlled suspension apparatus in accordance with a preferred embodiment of the present invention;

FIG. 2 presents a flowchart showing a damping force control method of the electronically-controlled suspension apparatus in accordance with a preferred embodiment of the present invention;

FIGS. 3A and 3B set forth a flowchart showing a damping force control method of the electronically-controlled suspension apparatus in accordance with a modified embodiment of the present invention; and

FIG. 4 displays a graph showing a stroke of a damper varying with time.

### DETAILED DESCRIPTION OF THE PREFERRED EMBODIMENTS

Hereinafter, embodiments of the present invention will be described in detail with reference to the attached drawings. Further, it should be noted that the following description of the embodiments of the present invention will be focused on only one set of a wheel and a damper for simplicity even though four sets thereof are mounted to a vehicle.

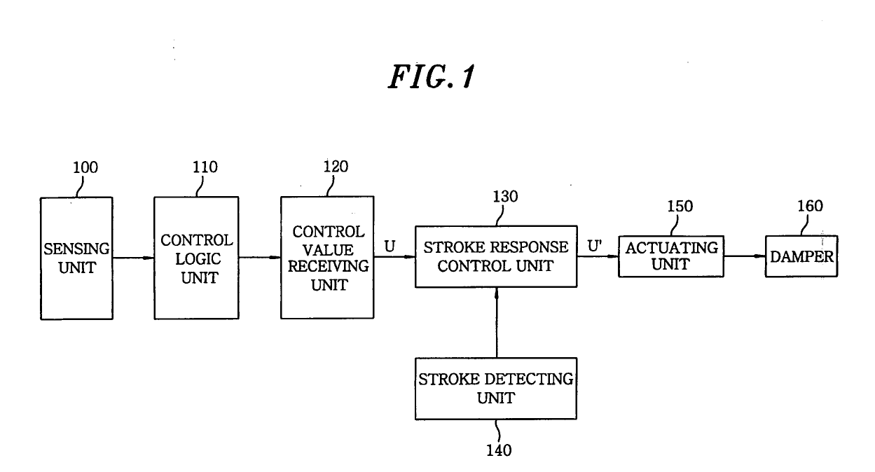

FIG. 1 is a block diagram of an electronically-controlled suspension apparatus in accordance with a preferred embodiment of the present invention. As shown in FIG. 1, the electronically-controlled suspension apparatus of the present invention includes a sensing unit 100, a control logic unit 110, a control value receiving unit 120, a stroke response control unit 130, a damper 160 installed between a vehicle body and a wheel axle, an actuating unit 150 for controlling damping force characteristics of the damper 160 and a stroke detecting unit 140 for detecting a stroke of the damper 160.

The sensing unit 100 includes a first sensing device for detecting vertical movements of the vehicle body, such as a vehicle body vertical acceleration sensor and a vehicle height sensor, a second sensing device for detecting lateral movements of a vehicle, such as a steering angle sensor and a lateral acceleration sensor, and/or a third sensing device for sensing longitudinal movements of the vehicle, such as a speed sensor, a brake on/off sensor and a TPS (throttle position sensor). The sensing unit 100 provides various values, detected by the first, second and third sensing device, to the control logic unit 110.

The control logic unit 110 for determining control values by using the detected values from the sensing unit 100 includes a riding comfort control part for preventing riding comfort of the vehicle from deteriorating due to an uneven road surface; a roll control part for enhancing stability of the vehicle during turning movements thereof; and/or a dive and squat control part for preventing a nose-up or nose-down of the vehicle body when the vehicle accelerates or decelerates. The control logic unit 110 provides the control values, generated by the aforementioned control parts, to the control value receiving unit 120.

The control value receiving unit 120 determines a control command value U for controlling the damping force characteristics of the damper 160 by using the control values provided from the control logic unit 110 and, thereafter, provides the control command value U to the stroke response control unit 130.

The stroke detecting unit 140 detects a relative displacement of the vehicle body with respect to the wheel axle (or the stroke of the damper 160) and provides the detected relative displacement to the stroke response control unit 130. The stroke detecting unit 140 can be constituted by a vehicle height sensor or a stroke sensor installed between the vehicle body and the wheel axle. Alternatively, the stroke detecting unit 140 can be constituted by a device capable of calculating the relative displacement by using vertical accelerations which are detected by two vertical acceleration sensors mounted to the wheel axle and the vehicle body, respectively. More particular, the vertical velocities of the vehicle body and the wheel axle are obtained by integrating the vertical accelerations of the vehicle body and wheel axle which are detected by two vertical acceleration sensors mounted to the wheel axle and vehicle body, respectively. Then, a relative velocity of the vehicle body with respect to the wheel axle is calculated from a difference between the vertical velocities of the vehicle body and the wheel axle. Thereafter, the relative distance, that is, the relative displacement of the vehicle body with respect to the wheel axle (or the stroke of the damper 160) is obtained by integrating the calculated relative velocity. At this time, the stroke detecting unit 140 can provide the relative velocity as well as the relative displacement to the stroke response control unit 130.

If the stroke detecting unit 140 uses sensors constituting the sensing unit 100, the stroke detecting unit 140 may be regarded as one of the elements constituting the sensing unit 100.

The stroke response control unit 130 selectively adjusts the control command value U, provided from the control value receiving unit 120, with reference to the relative displacement provided from the stroke detecting unit 140, thus determining a control command adjusted value U′ for increasing the extension or compression damping force of the damper 160. The determined control command adjusted value U′ is provided to the actuating unit 150. The actuating unit 150 is operated according to the control command adjusted value U′ or control command value U, provided from the stroke response control unit 130, thus adjusting the damping force of the damper 160.

In the above-described preferred embodiment of the present invention, the control command value U is adjusted by the stroke response control unit 130 with reference to the relative displacement. However, as described below, the control command value U may be adjusted with reference to the relative velocity as well as the relative displacement.

In this case, if the stroke detecting unit 140 is constituted by the vehicle height sensor, the stroke response control unit 130 may further include a differentiator (not shown) which calculates the relative velocity by differentiating the relative displacement provided from the stroke detecting unit 140. Then, the stroke response control unit 130 selectively adjusts the control command value U with reference to the relative displacement and the relative speed generated from the differentiator, thus determining the control command adjusted value U′ for increasing or reducing the extension or compression damping force of the damper 160.

If the stroke detecting unit 140 is constituted by two vertical acceleration sensors mounted to both the vehicle body and the wheel axle, respectively, the stroke detecting unit 140 can obtain the velocities of the vehicle body and wheel axle by integrating the accelerations of the vehicle body and the wheel axle. Then, the relative velocity of the vehicle body with respect to the wheel axle is calculated from the difference between the velocities of the vehicle body and wheel axle. Thereafter, the stroke detecting unit 140 obtains the relative displacement by integrating the relative velocity. Then, the stroke detecting unit 140 provides the relative velocity and the relative displacement to the stroke response control unit 130. The stroke response control unit 130 selectively adjusts the control command value U with reference to both the relative velocity and the relative displacement, which are provided from the stroke detecting unit 140. Thus, the stroke response control unit 130 determines the control command adjusted value U′ for increasing or reducing the extension or compression damping force of the damper 160.

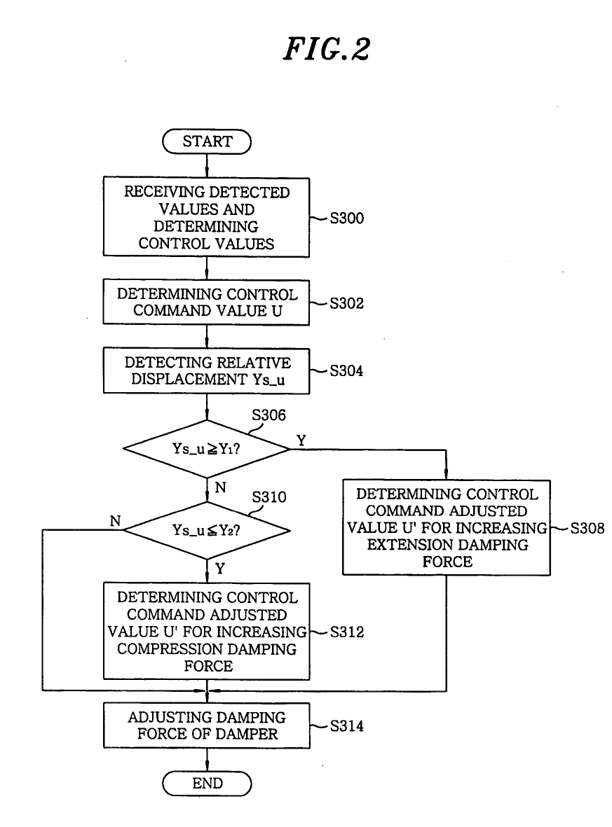

Hereinafter, damping force control methods of the electronically-controlled suspension apparatus having the above-mentioned construction in accordance with a preferred embodiment and modified embodiment of the present invention will be described with reference to FIGS. 2 through 4.

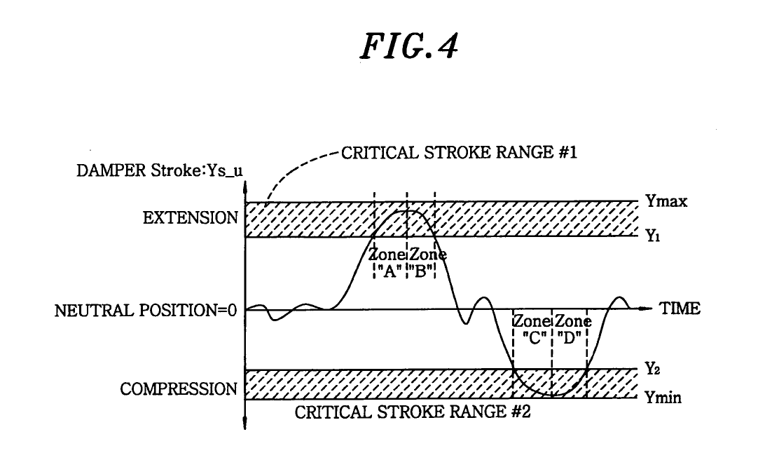

FIG. 2 is a flowchart showing the damping force control method of the electronically-controlled suspension apparatus in accordance with the preferred embodiment of the present invention. FIG. 4 is a graph for showing the stroke of the damper 160 varying with the time.

As shown in FIG. 2, the control logic unit 110 receives values detected by and provided from the sensing unit 100 and determines control values based on the values detected by the sensing unit 100, and provides the control value to the control value receiving unit 120 (step S300). The control value receiving unit 120 determines a control command value U based on the control values provided from the control logic unit 110, and provides the control command value U to the stroke response control unit 130 (step S302).

The stroke response control unit 130 receives the stroke of the damper 160 detected by the stroke detecting unit 140, that is, the relative displacement Ys_u of the vehicle body with respect to the wheel axle (step S304). Furthermore, the stroke response control unit 130 determines whether or not the relative displacement Ys_u is equal to or greater than a first preset value Y₁ (step S306).

If the relative displacement Ys_u is equal to or greater than the first preset value Y₁, that is, as shown in FIG. 4, when the relative displacement Ys_u is in a critical stroke range #1 in which the probability of occurrence of a full extension is very high, the stroke response control unit 130 adjusts the control command value U to determine a control command adjusted value U′ for increasing an extension damping force of the damper 160, and provides the determined control command adjusted value U′ to the actuating unit 150 (step S308). Then, the actuating unit 150 is operated to adjust the damping force of the damper 160 according to the control command adjusted value U′ provided from the stroke response control unit 130 (step S314).

If, at step S306, the relative displacement Ys_u is less than the first preset value Y₁, the stroke response control unit 130 determines whether or not the relative displacement Ys_u is less than or equal to a second preset value Y₂ (step S310).

At step S310, when the relative displacement Ys_u is less than or equal to the second preset value Y₂, that is, as shown in FIG. 4, when the relative displacement Ys_u is in a critical stroke range #2 in which the probability of occurrence of a full bumping is very high, the stroke response control unit 130 adjusts the control command value U to determine a control command adjusted value U′ for increasing the compression damping force of the damper 160, and provides the control command adjusted value U′ to the actuating unit 150 (step S312). Then, the actuating unit 150 is operated to adjust the damping force of the damper 160 according to the control command adjusted value U′ provided from the stroke response control unit 130 (step S314).

As described above, in the case where the relative displacement Ys_u is in the critical stroke range #1 or #2, the stroke response control unit 130 provides the control command adjusted value U′, which is increased by a preset amount from the control command value U for controlling the extension or compression damping force of the damper 160, thus hardening the damper 160. Therefore, the full extension or the full bumping can be prevented from occurring in the damper 160. As well, the stroke of the damper 160 can rapidly escape from the critical stroke range #1 or #2.

If, at step S310, the relative displacement Ys_u is greater than the second preset value Y₂, that is, if the relative displacement Ys_u is between the first and second preset values Y₁ and Y₂, the stroke response control unit 130 provides the control command value U, received from the control value receiving unit 120, to the actuating unit 150.

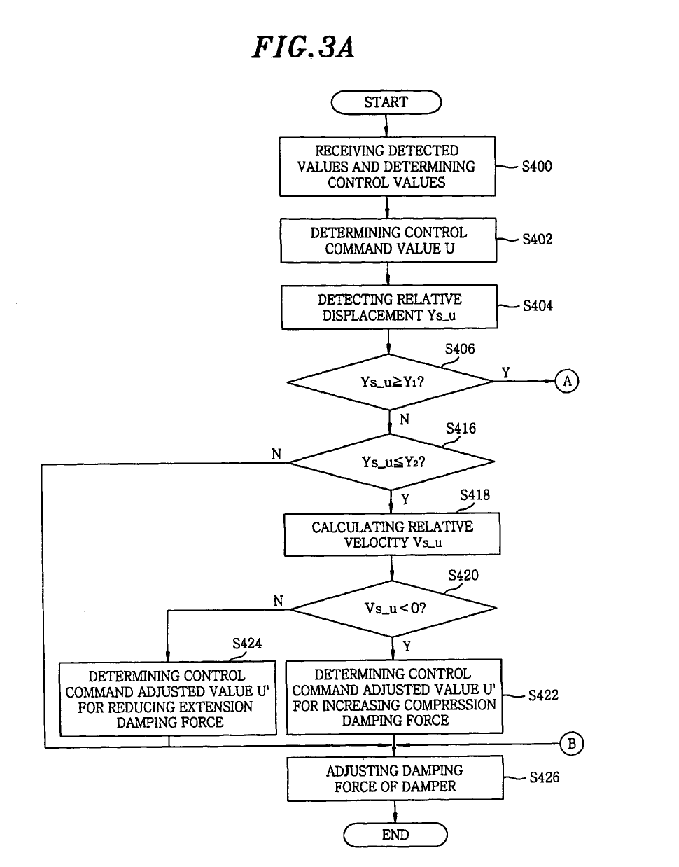

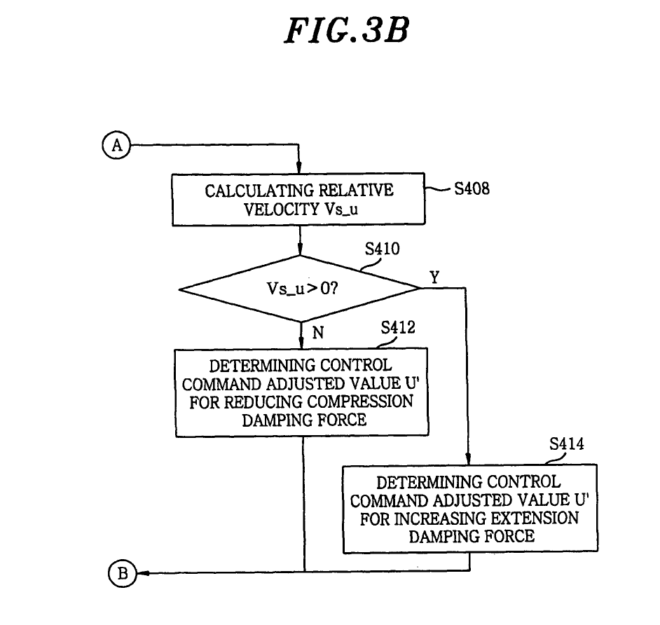

FIGS. 3A and 3B are a flowchart showing a damping force control method of the electronically-controlled suspension apparatus in accordance with the modified embodiment of the present invention, wherein the damping force control method using the relative velocity as well as the relative displacement will be described.

As shown in FIGS. 3A and 3B, the control logic unit 110 receives values detected by the sensing unit 100 and determines control values from the detected values to provide the determined control values to the control value receiving unit 120 (step S400). The control value receiving unit 120 determines a control command value U from the control values, provided from the control logic unit 110, and provides the control command value U to the stroke response control unit 130 (step S402).

The stroke response control unit 130 receives the stroke of the damper 160 detected by the stroke detecting unit 140, that is, the relative displacement Ys_u of the vehicle body with respect to the wheel axle (step S404). The stroke response control unit 130 determines whether the relative displacement Ys_u is equal to or greater than a first preset value Y₁ (step S406).

If, at step S406, the relative displacement Ys_u is equal to or greater than the first preset value Y₁, that is, as shown in FIG. 4, when the relative displacement Ys_u is in the critical stroke range #1, the stroke response control unit 130 calculates a relative velocity Vs_u by differentiating the relative displacement Ys_u (step S408). Thereafter, the stroke response control unit 130 determines whether the relative velocity Vs_u is greater than 0 (or positive) (step S410).

If, at step S410, the relative velocity Vs_u is greater than 0 (in a zone “A” of FIG. 4) , the stroke response control unit 130 adjusts the control command value U, and determines a control command adjusted value U′ for increasing the extension damping force of the damper 160, and provides the control command adjusted value U′ to the actuating unit 150 (step S414). Then, the actuating unit 150 adjusts the damping force of the damper 160 according to the control command adjusted value U′ provided from the stroke response control unit 130 (step S426).

If, at step S410, the relative velocity Vs_u is less than or equal to 0 (in a zone “B” of FIG. 4), the stroke response control unit 130 adjusts the control command value U, and determines a control command adjusted value U′ for reducing the compression damping force of the damper 160, and provides the control command adjusted value U′ to the actuating unit 150 (step S412). Then, the actuating unit 150 adjusts the damping force of the damper 160 according to the control command adjusted value U′ provided from the stroke response control unit 130 (step S416).

If, at step S406, the relative displacement Ys_u is less than the first preset value Y₁, the stroke response control unit 130 determines whether the relative displacement Ys_u is less than or equal to a second preset value Y₂ (step S416).

At step S416, when the relative displacement Ys_u is less than or equal to the second preset value Y₂, that is, as shown in FIG. 4, when the relative displacement Ys_u is in the critical stroke range #2, the stroke response control unit 130 calculates a relative velocity Vs_u by differentiating the relative displacement Ys_u (step S418). Thereafter, the stroke response control unit 130 determines whether the relative velocity Vs_u is less than 0 (or negative) (step S420).

If, at step S420, the relative velocity Vs_u is less than 0 (in a zone “C” of FIG. 4), the stroke response control unit 130 adjusts the control command value U, and determines a control command adjusted value U′ for increasing the compression damping force of the damper 160, and provides the control command adjusted value U′ to the actuating unit 150 (step S422). Then, the actuating unit 150 controls the damping force of the damper 160 according to the control command adjusted value U′ (step S426).

If, at step S420, the relative velocity Vs_u is equal to or greater than 0 (in a zone “D” of FIG. 4), the stroke response control unit 130 adjusts the control command value U, and determines a control command adjusted value U′ for reducing the extension damping force of the damper 160, and provides the control command adjusted value U′ to the actuating unit 150 (step S424). Then, the actuating unit 150 controls the damping force of the damper 160 according to the control command adjusted value U′ (step S426).

As described above, in the case where the relative displacement Ys_u is in the critical stroke range #1 or #2, the stroke response control unit 130 provides a control command adjusted value U′, which is increased or reduced by a preset amount from the control command value U, to control the extension or compression damping force of the damper 160. Therefore, the stroke of the damper 160 can rapidly escape from the critical stroke range #1 or #2. As well, the full extension or the full bumping is prevented from occurring in the damper 160.

If, at step S416, the relative displacement Ys_u is greater than the second preset value Y₂, that is, if the relative displacement Ys_u is between the first and second preset values Y₁ and Y₂, the stroke response control unit 130 provides the control command value U, received from the control value receiving unit 120, to the actuating unit 150.

In the electronically-controlled suspension apparatus according to the modified embodiment, although it has been explained that the stroke detecting unit 140 provides only the relative displacement Ys_u to the stroke response control unit 130, the stroke detecting unit 140 may provide the relative velocity Vs_u as well as the relative displacement Ys_u to the stroke response control unit 130. In detail, in the case where the stroke detecting unit 140 receives accelerations of the vehicle body and wheel axle which are detected by the vertical acceleration sensors mounted to both the vehicle body and the wheel axle, the stroke detecting unit 140 calculates the relative velocity and relative displacement using the accelerations of the vehicle body and the wheel axle to provide them to the stroke response control unit 130.

As described above, the present invention provides an electronically-controlled suspension apparatus and a damping force control method which hardens a damping force of a damper when a stroke of the damper (or a relative displacement of a vehicle body with respect to a wheel axle) is in a critical stroke range, thus preventing the full extension or the full bumping from occurring in the damper, thereby preventing inner components of the damper from being damaged, and enhancing the riding comfort of a vehicle.

While the invention has been shown and described with respect to the preferred embodiments, it will be understood by those skilled in the art that various changes and modifications may be made without departing from the spirit and scope of the invention as defined in the following claims.

1. An electronically-controlled suspension apparatus, which is provided with a damper installed between a vehicle body and a wheel axle, comprising:
a stroke detecting unit for detecting a relative displacement of the vehicle body with respect to the wheel axle;
a stroke response control unit, which determines a control command adjusted value for increasing an extension or compression damping force of the damper when the relative displacement is equal to or greater than a first predetermined value, or is less than or equal to a second predetermined value; and
an actuating unit which is operated according to the control command adjusted value, thus adjusting the extension or compression damping force of the damper.

2. The apparatus of claim 1, wherein the stroke detecting unit is provided with a vehicle height sensor installed between the vehicle body and the wheel axle.

3. The apparatus of claim 1, wherein the stroke response control unit includes a differentiator for obtaining a relative velocity by differentiating the relative displacement, and determines the control command adjusted value for increasing or reducing the extension or compression damping force of the damper according to the stroke of the damper and the relative velocity.

4. The apparatus of claim 1, wherein the stroke detecting unit includes:
a first vertical acceleration sensor for detecting a vertical acceleration of the vehicle body, the first vertical acceleration sensor being mounted to the vehicle body; and
a second vertical acceleration sensor for detecting a vertical acceleration of the wheel axle, the second vertical acceleration sensor being mounted to the wheel axle,
wherein vertical velocities of the vehicle body and the wheel axle are obtained by integrating the vertical accelerations of the vehicle body and the wheel axle, so that a relative velocity of the vehicle body with respect to the wheel axle is obtained by using the vertical velocities of the vehicle body and the wheel axle to obtain the relative displacement by integrating the relative velocity.

5. A damping force control method of an electronically-controlled suspension apparatus which determines a control command value for controlling a damping force of a damper by using a piece of information about a driving state of a vehicle, road surface characteristics or intention of a driver, detected by sensing means, the damper being installed between a vehicle body and a wheel axle, the method comprising:
detecting a relative displacement of the vehicle body with respect to the wheel axle;
determining whether the relative displacement is equal to or greater than a first predetermined value, or is less than or equal to a second predetermined value;
determining a first control command adjusted value for increasing an extension damping force of the damper by adjusting the control command value when the relative displacement is equal to or greater than the first predetermined value;
determining a second control command adjusted value for increasing a compression damping force of the damper by adjusting the control command value when the relative displacement is less than or equal to the second predetermined value; and
adjusting the damping force of the damper according to the first or second control command adjusted value.

6. The method of claim 5, wherein the relative displacement is obtained by integrating a relative velocity calculated from a difference between vertical velocities of the vehicle body and wheel axle which are obtained by integrating vertical accelerations of the vehicle body and the wheel axle.

7. A damping force control method of an electronically-controlled suspension apparatus which determines a control command value for controlling a damping force of a damper by using a piece of information about a driving state of a vehicle, road surface characteristics or intention of a driver, detected by sensing means, the damper being installed between a vehicle body and a wheel axle, the method comprising:
obtaining a relative displacement of the vehicle body with respect to the wheel axle, and a relative velocity;
determining whether the relative displacement is equal to or greater than a first predetermined value, or is less than or equal to a second predetermined value, and whether or not the relative velocity is greater than 0;
determining a control command adjusted value by adjusting the control command value according to the relative displacement and the relative velocity, thus increasing or reducing an extension or an compression damping force of the damper; and
adjusting the damping force of the damper according to the control command adjusted value.

8. The method of claim 7, wherein the step of determining the control command adjusted value includes the sub-step of outputting the control command adjusted value for increasing the extension damping force of the damper when the relative displacement is equal to or greater than the first predetermined value and the relative velocity is greater than 0.

9. The method of claim 7, wherein the step of determining the control command adjusted value includes the sub-step of outputting the control command adjusted value for reducing the compression damping force of the damper when the relative displacement is equal to or greater than the first predetermined value and the relative velocity is less than or equal to 0.

10. The method of claim 7, wherein the step of determining the control command adjusted value includes the sub-step of outputting the control command adjusted value for increasing the compression damping force of the damper when the relative displacement is less than or equal to the second predetermined value and the relative velocity is less than 0.

11. The method of claim 7, wherein the step of determining the control command adjusted value includes the sub-step of outputting the control command adjusted value for reducing the extension damping force of the damper when the relative displacement is less than or equal to the second preset value and the relative velocity is equal to or greater than 0.

12. The method of claim 7, wherein the step of obtaining the relative displacement and the relative velocity includes the sub-steps of:
obtaining the vertical velocities of the vehicle body and the wheel axle by integrating vertical acceleration of the vehicle body and the wheel axle detected by vertical acceleration sensors mounted to both the vehicle body and the wheel axle;
obtaining the relative velocity by calculating a difference between the vertical velocities of the vehicle body and the wheel axle; and
integrating the relative velocity to obtain the relative displacement.

13. The method of claim 7, wherein the step of obtaining the relative displacement and the relative velocity includes the sub-steps of:
detecting the relative displacement; and
differentiating the relative displacement to obtain the relative velocity.
